(19) United States
(12) Patent Application Publication
(10) Pub. No.: US 2017/0034214 A1
(43) Pub. Date: Feb. 2, 2017

(54) APPARATUS AND METHOD FOR CROSS ENCLAVE INFORMATION CONTROL

(71) Applicant: Northrop Grumman Systems Corporation, Falls Church, VA (US)

(72) Inventors: Peter B. Houser, Poway, CA (US); Scott Alan Rosebush, San Diego, CA (US)

(21) Appl. No.: 14/813,688

(22) Filed: Jul. 30, 2015

(51) Int. Cl. H04L 29/06

(52) U.S. Cl. CPC H04L 63/20; H04L 63/0428

(57) ABSTRACT

A method for cross enclave information control is provided including causing the transmission of an information packet between a plurality of information enclaves on a communication bus. A respective information enclave of the plurality of information enclaves is associated with a respective enclave guard of a plurality of enclave guards. The method also includes controlling the entrance and exit of the information packet into and out of the respective information enclave by the respective enclave guard.

### TECHNICAL FIELD

Example embodiments generally relate to cross enclave information sharing, in particular, relate to cross enclave information control.

### BACKGROUND

Digital data communications computing aggregations may include information enclaves, i.e., logically segregated systems of information processing equipment, which may have differencing levels of sensitivity require correspondingly different methods of information protection. Some such levels of sensitivity may be associated with authorization to operate (ATO), e.g. certifications of classification level, for example, Department of Defense (DOD) security classification, such as No Foreign Nationals (NOFORN), Confidential, Secret, Top Secret, or the like; qualification or operation safety/criticality classification, such as described in DO-178B; processes for verification, e.g. requirements cascading to suppliers, or the like. In some instances information of a higher sensitivity may be restricted from entering a lower level enclave to prevent inadvertent release of critical information, in other instances lower sensitivity information may be prevented from entering a higher sensitivity to prevent corruption. The tightly controlled interfaces, such as cross domain systems may control the information flow between enclaves.

Communications between enclaves in some computing aggregations may be configured point-to-point. Each enclave may have a discrete connection with the respective enclaves in the computing aggregation, such as the cross domain computing aggregation of FIG. 3A. Data transfer between the respective enclaves may be controlled by a cross domain system associated with each enclave-to-enclave connection. Each of the cross domain guards, e.g. an information assurance system for automatically accessing or transferring information between two or more differing sensitivities, may have data control rules specific to the enclaves to which they connect. The addition of an enclave to a point-to-point enclave computing aggregation may require a new connection to be made between the added enclave and each of the respective enclaves of the computing aggregation, each connection having its own distinct cross domain system. Although a point-to-point enclave may allow for very specific rules for each connection, thereby allowing for simplified ATO of the cross domain guard, the number of connections and separate cross domain systems creates a highly complicated computing aggregation, precluding open system designs that span a group of, or all, enclaves.

Other communications between enclaves within computing aggregations may be configured in a star formation, in which each of the enclaves may be connected to a single cross domain guard, such as the cross domain platform of FIG. 3B. Data transferred between any of the enclaves may be controlled by the central cross domain guard. This configuration may allow greater flexibility, since an additional enclave may be added by a single connection to the central cross domain system. However, the star cross domain computing aggregation may have communications rules which may be complicated and therefore not capable of ATO; and the use of a single central domain guard creates a single point failure which if disabled would terminate all inter-enclave communication.

Since communication equipment and connections are not shared between enclaves there may be a limit to cyber and communication resilience.

### BRIEF SUMMARY OF SOME EXAMPLES

Accordingly, some example embodiments may enable cross enclave information control, as described below. In one example embodiment, a computing aggregation is provided including a plurality of information enclaves, a communication bus configured to transfer information packets between the plurality of information enclaves, and a plurality of enclave guards. A respective enclave guard is associated with a respective information enclave and an information packet entering or exiting the respective information enclave is controlled by the respective enclave guard.

In another embodiment a method of information control is provided including causing the transmission of an information packet between a plurality of information enclaves on a communication bus. A respective information enclave of the plurality of information enclaves is associated with a respective enclave guard of a plurality of enclave guards. The method also includes controlling the entrance and exit of the information packet into and out of the respective information enclave by the respective enclave guard.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system that may be useful in connection with cross enclave information control according to an example embodiment;

FIG. 2 illustrates a functional block diagram of an apparatus that may be useful in connection with cross enclave information control according to an example embodiment;

FIG. 3A illustrates a computing aggregation utilizing point-to-point cross enclave communications;

FIG. 3B illustrates a computing aggregation utilizing star cross enclave communication;

FIG. 3C illustrates a computing aggregation utilizing bussed cross enclave communications with enclave guards associated with each enclave according to an example embodiment;

FIG. 4 illustrate a functional diagram of an enclave guard in accordance with some example embodiments;

FIG. 5 illustrates an example multi-level bus cross enclave computing aggregation with enclave guards associated with each enclave in accordance with an example embodiment; and

FIG. 6 illustrates a method of cross enclave information control in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

The term “information enclave” or “enclave,” as described herein, shall be interpreted as a secure computing environment including at least one computing device, data storage device, and/or media output device. The enclave may optionally include a local network for interconnecting multiple computing devices, data storage devices, and/or media output devices. The enclave may also optionally include a means for securely connecting the enclave to a different enclave which is operating at an identical level of sensitivity. In an example embodiment, an enclave may include communications systems, such as radios, terrestrial fibers, or the like, which link the enclave with remote users at the same sensitivity level. In some example embodiments, an enclave may be firewalled from outside intrusion and accessible only to authorized users and/or devices.

In some examples, the present invention may provide an apparatus and method for controlled cross enclave information movement when the enclaves are at differing levels of sensitivity. Processing assets of a computing aggregation, such as a those installed within a building, ship, aircraft, department, or the like may be partitioned into information enclaves. Information packets may be transferred between enclaves by routing the information packets on a trusted, multi-level communication bus common to two or more information enclaves. Each information enclave may include or be associated with an enclave guard which controls the information packets entering or exiting the respective information enclave.

In some embodiments, the enclave guards control the information packet entrance and exit based on the sensitivity of the information packet. The sensitivity of the information may be associated with an ATO, such as certification, e.g. DOD classifications; qualification, e.g. flight safety partition; or verification, e.g. cascaded requirements. The use of enclave guards specific to each information enclave allows for the data rules to be specific to the enclave simplifying the rules associated with the incoming and outgoing information packets. Further, an additional enclave may require only a single additional connection to the communication bus and may include its own enclave guard, therefore no changes to the connections or rules of other enclave guards may be necessary. Since an information enclave may be added and removed without affecting other information enclaves, the inter-enclave communication provides a flexible and resilient architecture.

In some embodiments, the enclave guard releasing the information may write a packet tag to the information packet which may identify the sensitivity level of the information packet. Information enclave guards may verify the packet tag and allow movement of the information packet in an instance in which the identified sensitivity level is appropriate for the information enclave.

Further security may be provided to inter-enclave communication, in some embodiments, by encryption of the information packets by the enclave guard and/or the information enclave. The encryption key used to decrypt the information packet by the receiving enclave guard or information enclave may be computing aggregation specific, sensitivity specific, or enclave specific. Multiple encryptions may be provided using keys which are aggregation specific, sensitivity specific, or enclave specific, e.g. cascading encryption. The encryption may prevent interception of information packets on the communication bus or by information enclaves with should not receive the information packet. In some instances, the packet tag may also be encrypted to prevent unauthorized enclaves from determining the sensitivity of the information packet.

In some example embodiments, enclave guards may write-down information in an information packet to a lower or non-sensitive level for data transfer between enclaves, such as by removal or obscurment of the sensitive information. The receiving enclave may be configured, in some instances to scan the information packet for malware or other evidence of corruption or compromise.

### Example System

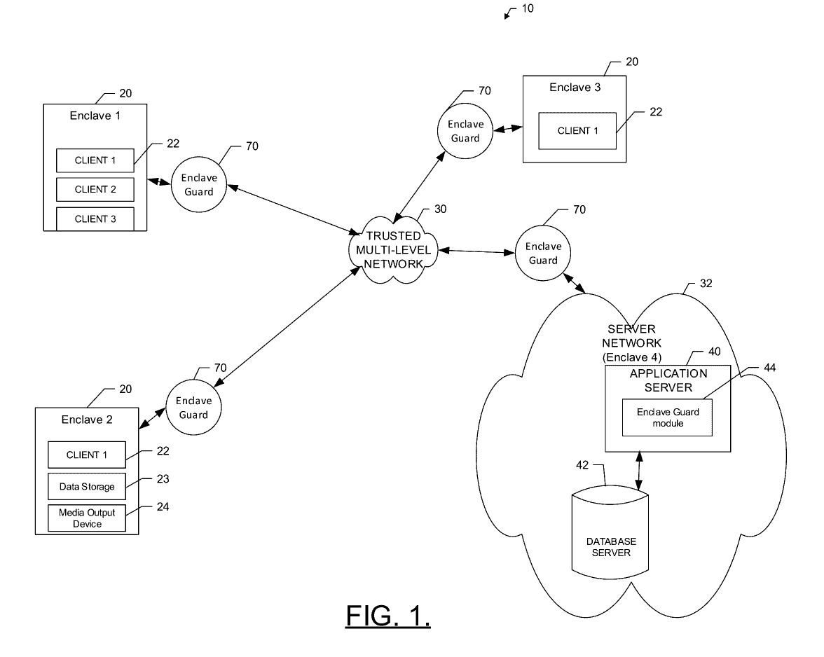

An example embodiment of the invention will now be described in reference to FIG. 1, which illustrates an example system in which an embodiment of the present invention may be employed. As shown in FIG. 1, an computing aggregation 10 according to an example embodiment may include one or more information enclaves (e.g. enclaves 20). Notably, although FIG. 1 illustrates three enclaves 20, it should be appreciated that a single enclave or many more enclaves 20 may be included in some embodiments and thus, the four enclaves 20 of FIG. 1 are simply used to illustrate a potential for a multiplicity of enclaves 20 and the number of enclaves 20 is in no way limiting to other example embodiments. In this regard, example embodiments are scalable to inclusion of any number of enclaves 20 being encompassed within the computing aggregation 10.

As discussed, an enclave 20 may include computing devices, e.g. clients 22, data storage devices 23, such as memories or databases, and/or media output device 24, such as printers, communication devices, or the like. Data may be transferred within an enclave 20 without sensitivity controls, or with enclave or device local controls.

An enclave 20 may, in some cases, be associated with a single organization, department within an organization, or location (i.e., with each one of the enclaves 20 being associated with an individual analyst of an organization, department or location). However, in some embodiments, each of the enclaves 20 may be associated with different corresponding locations, departments or organizations. For example, among the enclaves 20, one enclave may be associated with a first facility of a first organization and one or more of the other enclaves may be associated with a second facility of either the first organization or of another organization.

Each one of the clients 22 may include or otherwise be embodied as computing device (e.g. a computer, a network access terminal, a personal digital assistant (PDA), cellular phone, smart phone, or the like) capable of communication with a trusted, multi-level communication network 30. As such, for example, each one of the clients 22 may include (or otherwise have access to) memory for storing instructions or applications for the performance of various functions and a corresponding processor for executing stored instructions or applications. Each one of the clients 22 may also include software and/or corresponding hardware for enabling the performance of the respective functions of the clients.

The enclaves 20 may be in data communication with a trusted, multi-level communication network 30 via an enclave guard 70. The respective enclave guards may be associated with or included in respective enclaves 20. The enclave guard 70 may control information packets entering and/or exiting the respective enclave 20, as described in further detail below.

The trusted multi-level network 30, e.g. communication bus, may be a data network, such as a local area network (LAN), a metropolitan area network (MAN), a wide area network (WAN) (e.g. the Internet), and/or the like, which may couple the enclaves 20. Communication between the multi-level network 30 and the enclaves 20 may be accomplished by either wireline, (e.g. conductive cabling, optical fiber, or the like) or wireless communication (e.g. radio frequency) mechanisms and corresponding communication protocols, such as Transmission control protocol/Internet protocol (TCP/IP), Token ring, time division multiple access (TDMA), or the like. The trusted multi-level network may communicate information of multiple sensitivity level on a common communication bus.

In some embodiments, the trusted, multi-level network 30 may utilize a publish/subscribe system or messaging pattern. The trusted, multi-level communication bus 30 may be a broker or event bus performing store and forward functions to route information packets from publishers, e.g. a first enclave 20, to a subscriber, e.g. a second enclave. Additionally the trusted multi-level network 30 may prioritize information packages in a queue prior to routing, such as based on sensitivity. Additionally or alternatively, each publisher and subscriber in the publish/subscribe system may share metadata about each other via IP multi cast. The publishers and subscribers cache metadata and route messages based on the metadata.

In an example embodiment, devices to which the enclaves 20 may be coupled via the network 30 may also include one or more application servers (e.g. application server 40), and/or a database server 42, which together may form respective elements of a server network 32, e.g. enclave 4. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. For example, the application server 40 may include processing logic and memory enabling the application server 40 to access and/or execute stored computer readable instructions for performing various functions. In an example embodiment, one function that may be provided by the application server 40 may be the provision of access to information and/or services related to operation of the clients 22 with which the enclaves 20 are associated. For example, the application server 40 may be configured to provide for storage of information descriptive of documents, images, code, or the like. In some cases, these contents may be stored in the database server 42. Alternatively or additionally, the application server 40 may be configured to provide analytical tools for use by the clients 22 in accordance with example embodiments.

In some embodiments, for example, the application server 40 of the server network 32, and the enclaves 20, may therefore include an instance of a enclave guard module 44 comprising stored instructions for handling activities associated with practicing example embodiments as described herein. In an example embodiment the enclave guard module may be provided separate from the enclaves 20 as a portion of the enclave guard 70.

In an example embodiment, the application server 40, enclaves 20, or enclave guards 70 may include or have access to memory, such as an internal memory or the database server 42, for storing instructions or applications for the performance of various functions and a corresponding processor for executing stored instructions or applications. For example, the memory may store an instance of the enclave guard module 44 configured to operate in accordance with an example embodiment of the present invention. In this regard, for example, the enclave guard module 44 may include software for enabling the application server 40 to communicate with the network 30 for the provision and/or receipt of information associated with performing activities as described herein.

In some example embodiments, one or more enclaves 20 may be configured to operate a single level of sensitivity, e.g. secret classification, DOD-178 level B criticality, or the like. In some example embodiments, one or more enclaves 20 may be “trusted, multi-level enclaves” configured to operate at multiple levels of sensitivity, such as secret and top secret simultaneously.

### Example Apparatus

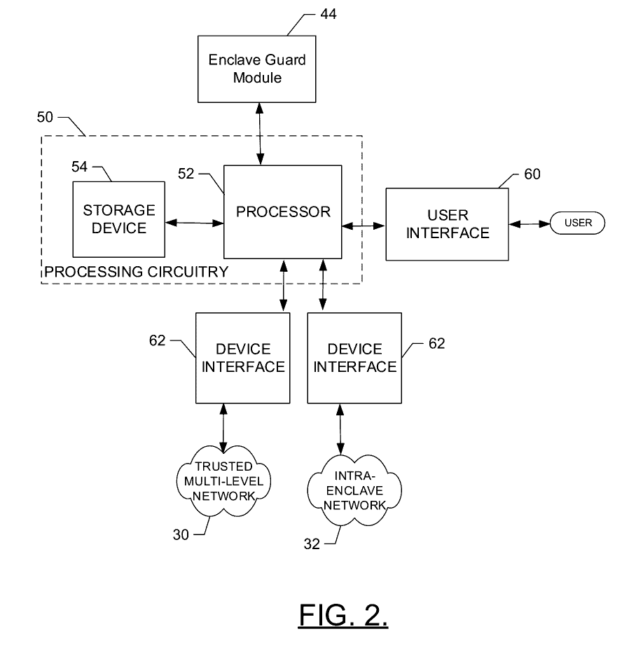

An example embodiment of the invention will now be described with reference to FIG. 2. FIG. 2 shows certain elements of an apparatus for cross enclave information control according to an example embodiment. The apparatus of FIG. 2 may be employed on an enclave guard (e.g. any of the enclave guards 70 of FIG. 1). The apparatus of FIG. 2 may, additionally or alternatively, be employed, for example, on a enclave (e.g. any of the enclaves 20 of FIG. 1) or a variety of other devices (such as, for example, a network device, server, proxy, or the like (e.g. the server network 32, e.g. enclave 4 of FIG. 1)). It should be noted that the devices or elements described below may not be mandatory and thus some may be omitted in certain embodiments.

Referring now to FIG. 2, an apparatus for cross enclave information control is provided. The apparatus may be an embodiment of the enclave guard module 44 or a device hosting the enclave guard module 44. As such, configuration of the apparatus as described herein may transform the apparatus into the enclave guard module 44. In an example embodiment, the apparatus may include or otherwise be in communication with processing circuitry 50 that is configured to perform data processing, application execution and other processing and management services according to an example embodiment of the present invention. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g. an integrated circuit chip) configured (e.g. with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g. at a computer terminal or client device such as one of the clients 22) that may be in communication with the processing circuitry 50 via the device interface 62 and/or a network (e.g. network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases. Alternatively, as indicated above, the user interface 60 may be remotely located.

The device interface or interfaces 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g. database server 42) that may store a variety of files, contents or data sets. Among the contents of the storage device 54, applications (e.g. client application 22 or service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g. physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the enclave guard module 44, which may be any means, such as, a device or circuitry operating in accordance with software or otherwise embodied in hardware or a combination of hardware and software (e.g. processor 52 operating under software control, the processor 52 embodied as an ASIC or FPGA specifically configured to perform the operations described herein, or a combination thereof) thereby configuring the device or circuitry to perform the corresponding functions of the enclave guard module 44 as described below.

The enclave guard module 44 may include tools to facilitate cross enclave information control. In an example embodiment the enclave guard module 44 may be configured to cause the transmission of an information packet between a plurality of information enclaves, such as enclaves 20, on a communication bus, such as trusted multi-level network 30. A respective information enclave 20 of the plurality of information enclaves 20 may be associated with a respective enclave guard 70 of a plurality of enclave guards 70. The enclave guard module 44 may be configured to control the entrance and exit of the information packet into and out of the respective information enclave 20 by a respective enclave guard 70 associated with a respective information enclave.

In some embodiments, the enclave guard module 44 may further include one or more components or modules that may be individually configured to perform one or more of the individual tasks or functions generally attributable to the enclave guard module 44. However, the enclave guard module 44 need not necessarily be modular. In cases where the enclave guard module 44 employs modules, the modules may, for example, be configured to control cross enclave information transfers, as described herein, encrypt information packets, tag information packets, and/or the like. In some embodiments, the enclave guard module 44 and/or any modules comprising the enclave guard module 44 may be any means such as a device or circuitry operating in accordance with software or otherwise embodied in hardware or a combination of hardware and software (e.g. processor 52 operating under software control, the processor 52 embodied as an ASIC or FPGA specifically configured to perform the operations described herein, or a combination thereof) thereby configuring the device or circuitry to perform the corresponding functions of the enclave guard module 44 and/or any modules thereof, as described herein.

### Example Cross Enclave Architectures

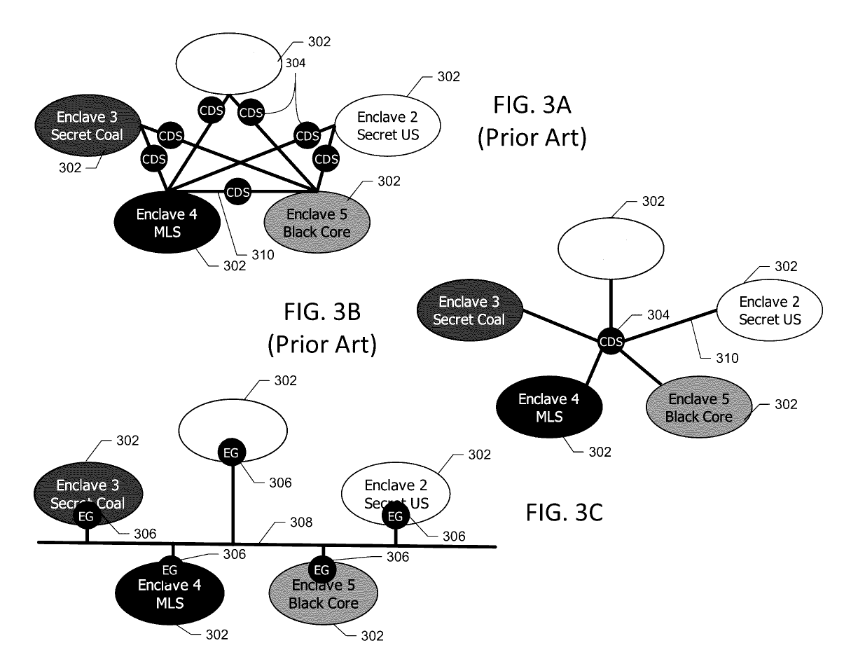

FIG. 3A illustrates a computing aggregation utilizing point-to-point cross enclave communications. The computing aggregation utilizing point-to point cross enclave communication may include a plurality of enclaves 302, cross domain systems (CDS) 304 and communication links 310. The example provided in FIG. 3 references security classifications based sensitivity for illustrative purposes only, one of ordinary skill in the art would immediately appreciate that alternative sensitivities may be used. The enclaves 302 may include enclave 1 with a security classification of TS/SCI, enclave 2 with a security classification of Secret US, enclave 3 with a security classification of Secret Coal, enclave 4 with a security classification of MLS, and enclave 5 with a security classification of Black Core. A wired or wireless communication link 310 may be established between each enclave pair. A discrete cross domain system 304 may be employed on each communication link 310. The cross domain system 304 may include and execute information control rules for information packet transfers between the two enclaves connected via the communication link 310.

In an instance in which an enclave 302 is removed or damaged, only the communication links associated with the severed enclave are disrupted, improving resiliency. However, if a component within an enclave 302 is damaged, the enclave cannot easily share use of similar components in other enclaves, reducing resiliency. Replacement or addition of an enclave 302 may require new communication links 310 to be created between each of the enclaves of the computing aggregation, for example an enclave added to the computing aggregation depicted may include five new communication links.

Enclaves may undergo an ATO process by a regulatory entity or company, for example National Security Agency (NSA), Federal Aviation Agency (FAA), or the like, to be considered a “certified/qualified device” for secure data processing. Point-to-point cross enclave computing aggregations may be relatively easy to ATO since the cross domain system 304 has only one set of rules for communication across the communication link 310, e.g. between the connected enclaves 302.

FIG. 3B illustrates a computing aggregation utilizing star cross enclave communications. The computing aggregation utilizing star cross enclave communications may include enclaves 302, communication links 310 and a central cross domain system 304. The enclaves 302 may be similar to the enclaves discussed in FIG. 3A. Each of the enclaves 302 may be connected to the central cross domain system 304. The central domain system 304 may include and execute rules for information packets transferred on the communication links 310.

The star cross enclave computing aggregation may provide a flexible architecture, since removal or addition of a enclave may require disruption or creation of only a single communication link 310 connected to the central cross domain system 304. However, the star cross enclave computing aggregation also has an inherent single point failure, in an instance in which the cross domain system 304 is damaged, corrupted, or otherwise rendered inoperable; no secure cross enclave information transferred would be possible. Further, because a single cross domain system 304 includes and executes rules for all information packet movement, the control rules may be exponentially complicated for each additional enclave. The complexity of the control rules may make ATO difficult, impracticable, or in some instances, impossible.

An example embodiment will now be described in general terms in relation to cross enclave information control according to the present invention. FIG. 3C illustrates a computing aggregation that utilizes bussed cross enclave communications with enclave guards associated with each enclave according to an example embodiment. The bus cross enclave computing aggregation may include enclave 302, a trusted, multi-level communication bus 308, and enclave guards 306. The enclaves 302 may be similar to the enclaves discussed above in FIGS. 3A and 3B. The enclaves 302 may be in data communication with each other via a trusted, multi-level communication bus 308, which may be substantially similar to the trusted, multi-level network as described in FIG. 1. The trusted multi-level communication bus 308 may be any wired or wireless communication system, such as conductive wiring (e.g. copper wiring or Ethernet cabling), radio frequency communications, fiber optic, virtual, or the like. The trusted multi-level communication bus 308 may communicate information packets of any sensitivity level between enclaves 302.

Each enclave 302 may include or be associated with an enclave guard 306 which controls any information packets entering or exiting the associated enclave. The enclave guards 306 may include an execute control rules of for the information packets entering or exiting the specific enclave 302.

The bus cross enclave computing aggregation may have a high resilience to failure of an enclave 302 since the failure will only affect the damage or failed enclave and will have no effect on the other enclaves connected to the multi-level communication bus 308. Since each enclave is connected to the trusted multi-level communication bus 308 and not to each other or to a central cross domain system, enclaves 302 may be added or removed without affecting the remaining enclaves. If a component within an enclave 302 is damaged, the enclave can easily share use of similar components in other enclaves, improving resiliency, using the trusted multi-level communication bus 308. ATO of the enclave guards 306 may be relatively simple since the enclave guard includes and executes only rules for information packets entering or exiting the specific enclave.

### Example Enclave Guard

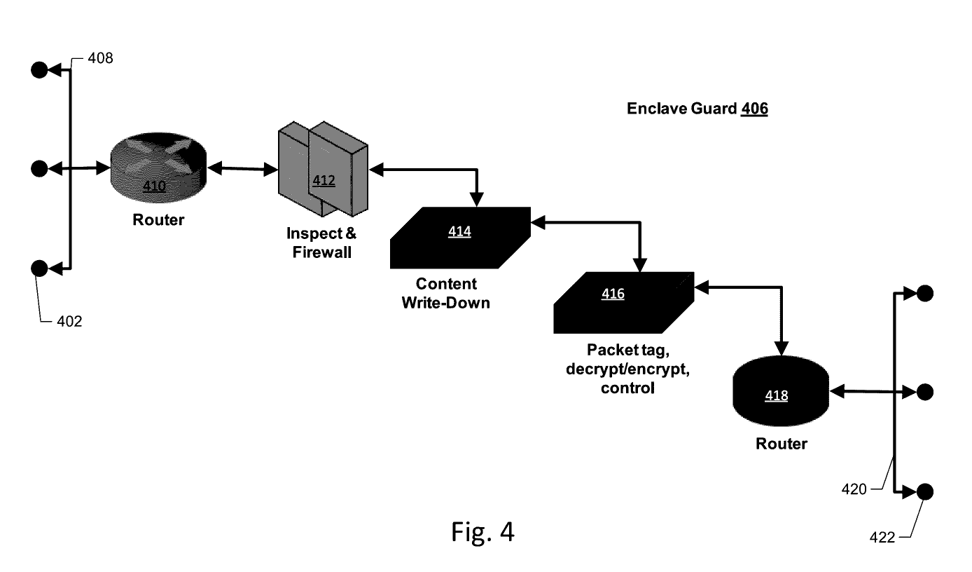

FIG. 4 illustrates a functional diagram of an enclave guard in accordance with some example embodiments. The enclave guard 406 may include an intra-enclave router 410, a firewall and inspection module 412, a content write-down module 414, packet tag, encryption/decryption, and control module 416, and/or an trusted, multi-level bus router 418.

In the context of an information packet exiting the enclave 402, a device 408, such as a client, of the enclave may send an information packet or an information packet may be requested to another enclave 422. The intra-enclave router 410 may receive the information packet and pass it to the inspect and firewall module 412.

The inspect and firewall module 412 may be a firewall, such as a stateful firewall. The inspection and firewall module 412 may track the state of network or communication bus 408 connections, such as transmission control protocol (TCP) streams, user diagram protocol (UDP) communication, or the like, traveling across it. The inspection and firewall module 412 may perform inspections of the information packet, such as stateful packet inspections, to verify that the information packet is legitimate and that the packet is matched to a known active connection. In some example embodiments, the inspection and fire wall module 412 may be configured to scan the information packet for malware. In an instance in which the information packet passes the inspection, the inspection and firewall module 412 may pass the information packet to the content write-down (CWD) module 414. In an instance in which the information packet fails the inspection it may be rejected, such as deleted, quarantined, or the like. In some example embodiments, the firewall 412 may be configured to meet specific user or entity requirements.

The CWD 414 module may write down the information packet, e.g. remove bits or specific information within the information packet to reduce the sensitivity level, for example secret to confidential. In an instance in which the information packet is written-down, the packet tag written to the information packet by the PEDC module may be indicative of the write-down/up sensitivity level, the original sensitivity level, or both. The CWD model 414 may pass the information packet to packet tag, encrypt/decrypt, and control (PEDC) module 416.

The PEDC module 416 may write a packet tag to the information packet, for example as a header, trailer, appendix, or the like. The header may include a sensitivity level for the enclave and/or the information packet, such as secret, top secret, flight critical A, fight critical C, or the like.

In some example embodiments, the PEDC module 418 may encrypt the information packet. The information packet may be encrypted using a symmetric key encryption, public key encryption, or the like. In some example embodiments, the packet tag may be encrypted with the information packet so the sensitivity level of the information packet is obfuscated to any enclave connected to the trusted multi-level communication bus 420 which does not possess the appropriate key. In an example embodiment the encryption key may be sensitivity specific, e.g. enclaves with secret classification can decrypt information packets with secret, or in some cases secret or lower classification. In other instances, the encryption key may be computing aggregation specific, limiting or preventing decryption by enclaves not local to the computing aggregation. The PEDC module 416 may pass the information packet to the trusted, multi-level bus router 418. The trusted, multi-level bus router 418 may address and cause transmission of the information packet. The trusted, multi-level bus router 418 may address the information packet with the address of the enclave 422, enclave guard 406 associated with the enclave, and/or a device within the enclave. The trusted multi-level bus router 410 may transmit the information packet by broadcasting the information packet on the trusted multi-level communication bus 4420.

Turning to the receipt of an information packet, the trusted multi-level bus router 418 may monitor the trusted multi-level communication bus 420 for information packets addressed to the enclave guard 406, enclave 402, or a device within the enclave. In an instance in which an information packet is detected which has an address associated with the enclave, the router may pass the information packet to the PEDC module 416.

The PEDC module 416 may compare the information packet sensitivity level indicated by the packet tag to a information sensitivity level threshold, for example the information sensitivity level threshold may be a specific sensitivity level, such as secret, or flight criticality B. In other instances the sensitivity level threshold may be a minimum sensitivity level, such as at least secret, or at least fight criticality C. In yet a further example, the sensitivity threshold may be a maximum sensitivity level, for example not higher than top secret or not higher than flight criticality D. In an instance in which the packet tag fails to satisfy the sensitivity level threshold, the enclave guard may reject the information packet, such as by deletion, quarantine, or the like, preventing entrance of the information packet into the enclave 420. In an instance in which the packet tag satisfies the sensitivity level threshold, the information may be passed to the enclave router 418 or decrypted.

In an instance in which the packet tag is encrypted, the PEDC module 416 may decrypt at least the packet tag portion of the information packet prior to comparing the packet tag to the sensitivity level threshold.

The PEDC module 416 may decrypt the information packet. The enclave guard 406 or the PEDC module 416 may possess the encryption key to decrypt the information packet and execute an appropriate decryption algorithm. In an example embodiment, the information packet may included cascading encryption, which may requires encryption keys which are aggregation specific, sensitivity specific, and/or enclave specific. The decrypted information packet may be passed to the CWD module 614.

The CWD module 414 may pass the information packet to inspection and firewall module 412.

The inspection and firewall module 412 may perform a firewall inspection, such as the stateful packet inspection, to verify the information packet is legitimate and that the information packet is matched to a known active connection. In some example embodiments, the inspection and fire wall module 412 may be configured to scan the information packet for malware. In an instance in which the information packet passes the inspection, the information packet may be passed to the inter-enclave router 410. In an instance in which the information packet fails the inspection it may be rejected, such as deleted, quarantined, or the like.

The intra-enclave router 418 may be configured to address and transmit the information packet to one, a group, or all devices 4202 connected to the enclave 408. One or more devices 402 may store, process, analyze, or otherwise utilize the information packet.

### Example Cross Enclave Computing Aggregation

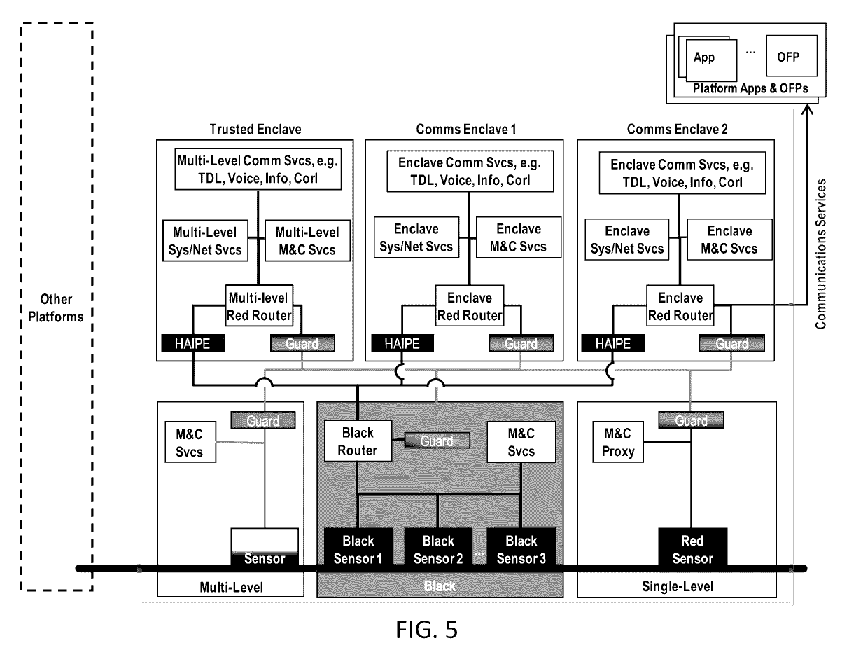

FIG. 5 illustrates an example multi-level bus cross enclave computing aggregation with enclave guards associated with each enclave in accordance with an example embodiment. The multi-level bus cross enclave computing aggregation may include a trusted enclave, a first communication enclave (comms enclave 1), a second communications enclave (comms enclave 2), a multilevel enclave, a black enclave, and a single level enclave. Each enclave may be connected to a trusted multi-level communication bus by means of an enclave guard (guard) of the respective enclaves.

The trusted enclave, comms enclave 1 and 2 and black enclave may additionally be in data communication through a secure point-to-point cross enclave architecture. The point-to-point cross enclave architecture may include high assurance internet port encryptors (HAIPEs) which connect enclaves at a specific level of sensitivity to other enclaves that are at that same level of sensitivity. The use of HAIPEs may allow for backwards compatibility with previous secured communication systems.

The trusted enclave may process information at multiple sensitivity levels. The multi-level red router may propagate information packets within the enclave to the appropriate locations, as well as send information packets to the enclave guard or HAIPE for transmission external to the enclave. The “red” in the router may correspond to a specific or highest sensitivity level for the enclave, such as secret, or flight criticality C. In some example embodiments the red router may be a military specification router, such as an automated digital network system (ADNS). The trusted enclave may also include, multilevel system/network services, multi-level management and control services, and multilevel communications services, e.g. tactical datalink (TDL), voice, information, correlation/fusion, or the like.

The communication enclaves may include an enclave red router configured to propagate information packets within the enclave and to the enclave guard or HAIPE for transmission external to the enclave. The communications enclaves may also include enclave system/network services, enclave management and control services, and enclave communication services, e.g. TDL, voice, info, correlation/fusion, or the like. In an example embodiment of a communications enclave, such as communications enclave 2 as depicted, the enclave red router may also propagate information packets to computing aggregation application and services, such as an operational flight program (OFP), via computing aggregation communication services, such as Future Airborne Capability Environment (FACE™) or Open Mission Systems (OMS) compliant services

The multi-level enclave may include a multi-level sensor, e.g. classified RF communication transceiver, signal interceptor, or the like configured for multiple sensitivity levels and management and control services. The multi-level sensor may send or receive information packets across computing aggregations using communication systems, such as radio frequency transmission, internet, or the like, to or from other computing aggregations.

The black enclave may include a black router, management and control services, and one or more black sensors. “Black” may be indicative that the data within the enclave is encrypted, e.g. cyphertext. In some example embodiments the black router may be a military specification router, such as an automated digital network system (ADNS). The black sensors may be classified RF communication transceiver, signal interceptor, or the like. The black sensors may send or receive information packets across computing aggregations using communication systems, such as radio frequency transmission, internet, or the like, to or from other computing aggregations.

The single-level enclave may include a management and control proxy, and a red sensor. The red sensor may be classified RF communication transceiver, signal interceptor, or the like. The red sensor may send or receive information packets across computing aggregations using communication systems, such as radio frequency transmission, internet, or the like, to or from other computing aggregations.

### Example Method for Cross Enclave Information Control

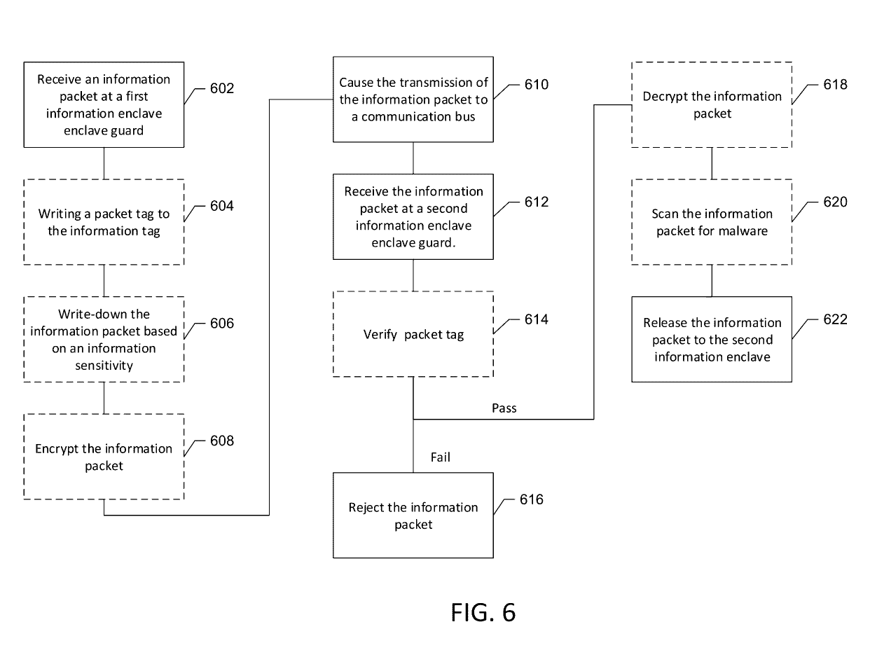

From a technical perspective, the enclave guard module 44 described above may be used to support some or all of the operations described above. As such, the computing aggregation described in FIG. 2 may be used to facilitate the implementation of several computer program and/or network communication based interactions. As an example, FIG. 6 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an enclave guard, such as enclave guard 70, or an enclave 20 of FIG. 1 and executed by a processor in the enclave guard. As will be appreciated, any such computer program instructions may be loaded onto a computer or other programmable apparatus (e.g. hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention is shown in FIG. 6. The method may be employed for cross enclave information control. The method may include, receiving an information packet at a first information enclave enclave guard, at operation 602. The method may also include causing the transmission of the information packet to the communication bus, at operation 610. At operation 612, the method may include receiving the information packet at a second information enclave enclave guard. The method, at operation 616, may include rejecting the information packet, or at operation 622 the method may include releasing the information packet to the second information enclave.

In an example embodiment, the method may optionally include, as denoted by the dashed box, operation 604, writing a packet tag to the information tag. The method may also optionally include down-writing the information packet based on an information sensitivity, at operation 606. The method my optionally further include verifying the packet tag, at operation 614. At operation 618 the method may optionally include decrypting the information packet, and at operation 620, the method may optionally include writing-up the information packet. In an embodiment in which the packet tag is verified at operation 614, the method may continue at operation 618 if the verification passes or operation 616 if the verification fails.

In an example embodiment, an apparatus for performing the method of FIG. 6 above may comprise a processor (e.g. the processor 52) or processing circuitry configured to perform some or each of the operations (602-622) described above. The processor may, for example, be configured to perform the operations (602-622) by performing hardware implemented logical functions, executing stored instructions, or executing algorithms for performing each of the operations.

In some embodiments, the processor or processing circuitry may be further configured for additional operations or optional modifications to operations 602-622. In this regard, for example the respective enclave guards control the information packets entering and exiting the respective information enclaves based on an information sensitivity of the information packet. In an example embodiment, the plurality of information enclaves comprises a first information enclave and a second information enclave and the plurality of enclave guards comprises a first enclave guard associated with the first information enclave and a second information enclave associated with the second information enclave; and in an instance in which the information packet is routed from the first information enclave to the second information enclave, the first enclave guard writes a packet tag to the information packet prior to releasing the information packet onto the multi-level communication bus; and the second enclave guard verifies the packet tag prior to releasing the information packet to the second information enclave. In some example embodiments, the first enclave guard encrypts the information packet, and the second information enclave decrypts the information packet. In some example embodiments, the encryption and decryption is based on a local key. In an example embodiment, the encryption and decryption is based on an enclave specific key. In some example embodiments, the encryption comprises cascading levels of encryption. In some example embodiments, encryption of the information packet includes encryption of the packet tag. In an example embodiment, encryption of the information packet does not include encryption of the packet tag. In an example embodiment, the plurality of information enclaves comprises a first information enclave and a second information enclave and the plurality of enclave guards comprises a first enclave guard associated with the first information enclave and a second information enclave associated with the second information enclave and the first enclave guard writes-down the information packet based on an information sensitivity. In some example embodiments, an enclave guard of the plurality of enclave guards scans the information packet for malware. In an example embodiment, the communication bus comprises a trusted, multi-level communication bus.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A computing aggregation comprising:
a plurality of information enclaves;
a communication bus configured to transfer information packets between the plurality of information enclaves; and
a plurality of enclave guards, wherein a respective enclave guard is associated with a respective information enclave and an information packet entering or exiting the respective information enclave is controlled by the respective enclave guard.

2. The computing aggregation of claim 1, wherein the respective enclave guards control the information packets entering and exiting the respective information enclaves based on an information sensitivity of the information packet.

3. The computing aggregation of claim 1, wherein the plurality of information enclaves comprises a first information enclave and a second information enclave and the plurality of enclave guards comprises a first enclave guard associated with the first information enclave and a second information enclave associated with the second information enclave; and
wherein in an instance in which the information packet is routed from the first information enclave to the second information enclave, the first enclave guard writes a packet tag to the information packet prior to broadcasting the information packet onto the communication bus; and the second enclave guard verifies the packet tag prior to releasing the information packet to the second information enclave.

4. The computing aggregation of claim 3, wherein the first enclave guard encrypts the information packet, and the second information enclave decrypts the information packet.

5. The computing aggregation of claim 4, wherein the encryption and decryption is based on a local key.

6. The computing aggregation of claim 4, wherein the encryption and decryption is based on an enclave specific key.

7. The computing aggregation of claim 4, wherein the encryption comprises cascading levels of encryption.

8. The computing aggregation of claim 4, wherein encryption of the information packet includes encryption of the packet tag.

9. The computing aggregation of claim 4, wherein encryption of the information packet does not include encryption of the packet tag.

10. The computing aggregation of claim 1, wherein the plurality of information enclaves comprises a first information enclave and a second information enclave and the plurality of enclave guards comprises a first enclave guard associated with the first information enclave and a second information enclave associated with the second information enclave; and
wherein the first enclave guard writes-down the information packet based on an information sensitivity.

11. The computing aggregation of claim 1, wherein an enclave guard of the plurality of enclave guards scans the information packet for malware.

12. The computing aggregation of claim 1, wherein the communication bus comprises a trusted, multi-level communication bus.

13. A method of controlling information comprising:
causing the transmission of an information packet between a plurality of information enclaves on a communication bus, wherein a respective information enclave of the plurality of information enclaves is associated with a respective enclave guard of a plurality of enclave guards; and
controlling the entrance and exit of the information packet into and out of the respective information enclave by the respective enclave guard.

14. The method of controlling information of claim 13, wherein controlling the information entering or exiting the respective information enclave is based on an information sensitivity of the information packet.

15. The method of controlling information of claim 13 further comprising:
writing a packet tag to the information packet, by a first enclave guard of the plurality of enclave guards associated with a second information enclave of the plurality of information enclaves, prior to broadcasting the information packet to the communication bus; and
verifying the packet tag, by a second enclave guard of the plurality of enclave guards associated with a second information enclave of the plurality of enclave guards, prior to allowing the information packet to releasing the information packet to the second information enclave.

16. The method of controlling information of claim 15 further comprising:
encrypting the information packet by the first enclave guard; and
decrypting the information packet by the second enclave guard.

17. The method of controlling information of claim 16, wherein the encryption comprises cascading levels of encryption.

18. The method of controlling information of claim 13 further comprising:
writing down the information packet, by a first enclave guard of the plurality of enclave guards associated with a second information enclave of the plurality of information enclaves, prior to releasing the information packet to the communication bus

19. The method of controlling information of claim 13 further comprising:
scanning the information packet for malware, by an enclave guard of the plurality of enclave guards, prior to allowing the information packet to releasing the information packet to the second information enclave.

20. The method of controlling information of claim 13, wherein the communication bus comprises a trusted, multi-level communication bus.
